(19) United States
(12) Patent Application Publication
(10) Pub. No.: US 2010/0297397 A1
(43) Pub. Date: Nov. 25, 2010

(54) OPTICAL FILM AND MANUFACTURING METHOD THEROF

(76) Inventor: Lhien-Wen Chen, Taipei (TW)

Correspondence Address: DING YU TAN, Chengde Road, Sec 1, #83, 3F-1, Taipei, TW

(21) Appl. No.: 12/781,797

(22) Filed: May 17, 2010

(30) Foreign Application Priority Data
May 19, 2009 (TW) 098116486

(51) Int. Cl. B32B 3/10; B32B 37/24

(52) U.S. Cl. 428/156; 156/245

(57) ABSTRACT

An optical film, disposed in the backlight assembly, is provided. The optical film is manufactured by the following method. First, curing glue comprised of photocurable resin and thermosetting resin is provided. Compared to the curing glue as a whole, the percentage weight of the thermosetting resin is about 1%˜5%. Thereafter, the curing glue is illuminated and heated in order to form the optical film.

### FIELD OF INVENTION

The present invention relates to an optical film, especially relates to an optical film disposed in the backlight assembly.

### BACKGROUND OF THE INVENTION

In recent years, the traditional Cathode Ray Tube display, hereinafter referred to as CRT display, is gradually replaced by the liquid crystal display, hereinafter referred to as LCD display. The major reason for this trend is because that the radiation emitting from the LCD display is far less than the CRT display, and that the cost of the LCD display is significantly reduced. In general, the LCD display includes a backlight assembly and a LCD panel. The principal function of the backlight assembly is used as the light source for the LCD display.

In general, the backlight assembly includes a plurality of cold cathode fluorescent lamps, a reflective housing, a diffusion plate, a diffusion film, and a brightness enhancement film. The cold cathode fluorescent lamps are used to generate the light. The reflective housing is used to reflect the light from the cold cathode fluorescent lamps to the diffusion plate. The diffusion plate is used to diffuse the light from the cold cathode fluorescent lamps, in order to ensure further light illumination uniformity to the LCD panel, so as to reduce the non-uniform brightness phenomenon at the display surface of the LCD display. Because a plurality of diffusion particles are disposed in the diffusion plate, therefore, the transmittance of the diffusion plate is thereby decreased. Generally speaking, the transmittance of the diffusion plate is between 50% to 70%.

However, typically the use of the diffusion plate is not enough to overcome the non-uniform brightness phenomenon. Therefore, a diffusion film is needed to further diffuse the light. The diffusion film is an optical film having a plurality of diffusion particles thereon. In order to enhance the brightness throughout the entire viewing angle range, the brightness enhancement film is thereby added on the diffusion film.

Please refer to FIG. 1. FIG. 1 is a front view of a conventional brightness enhancement film 110. The brightness enhancement film 110 is comprised of a base plate 111 and a structured layer 112. The thickness of the base plate 111 is about 175 μm. The material of the base plate 111 is transparent polyethylene terephthalate, hereinafter referred to as PET. Furthermore, adhesives are coated on the base plate 111. The thickness of the structured layer 112 is about 25 μm. The material of the structured layer 112 is photosensitive acrylic resin. The structured layer 112 is combined and joined with the base plate 111 by using the adhesives. Due to the prismatic microstructures on the structured layer 112, the brightness enhancement film 110 is able to condense the light. Consequently, the angle for the emergent light from the brightness enhancement film 110 will become narrowed, so as to increase the brightness within the viewing angle range.

However, the usage of the base plate 111 will increase the overall material cost. Furthermore, based on the consideration of the optical quality, the base plate 111 must have higher transmittance, generally above 89%. Hence, the material cost will be further increased.

Moreover, some amount of light can be absorbed by the base plate 111 and the structured layer 112. Consequently, after entering into an incident surface 113 of the brightness enhancement film 110, the incident light L1 needs to pass through two mediums, i.e. the base plate 111 and the structured layer 112, before emitting from an emergent surface 114 of the brightness enhancement film 110. Therefore, the loss of light will be increased.

Hence, there is a need in the art for decreasing the material costs of the brightness enhancement film 110 and the loss of light.

### SUMMARY OF THE INVENTION

One object of the present invention is to provide an optical film and manufacturing method thereof. The optical film has lower material cost and can reduce the loss of light.

To achieve the foregoing and other object, an optical film is disclosed. The optical film used in the backlight assembly is mainly made by the following process. In the first step, a photocurable resin and a thermosetting resin are mixed together to form a curing glue. Compared to the curing glue as a whole, the percentage weight of the thermosetting resin is about 1%˜5%. In the second step, the curing glue is illuminated by light and heated to be cured to become a cured sample. In the third step, the optical film is formed, for example by cutting the cured sample into individual sheets. A plurality of first microstructures is disposed on the optical film.

In the optical film, the photocurable resin is an UV curing resin.

In the optical film, the first microstructures are disposed on the emergent surface of the optical film. The shape of the first microstructures is that of a prism or a hemi-sphere.

In order to achieve the predetermined mechanical strength, the thickness of the optical film is above 30 μm.

In the optical film, the thermosetting resin is selected from the group consisting of polyester and polyurethane.

To achieve the foregoing and other object, a manufacturing method of optical film is provided. The manufacturing method includes the following steps:

In the first step, an uncured curing glue is coated on a forming mold. A plurality of second microstructures is disposed on the forming mold. The curing glue, which is made by mixing the photocurable resin and the thermosetting resin, is coated on the second microstructures. The percentage weight of the thermosetting resin is about 1%˜5% compared to the weight of the curing glue as a whole.

In the second step, a pressing plate is covered on the curing glue. A release film is disposed between the pressing plate and the forming mold.

In the third step, the curing glue is illuminated by light, and is heated to be cured to become a cured sample.

In the fourth step, the cured sample is separated from the pressing plate and the forming mold.

In the fifth step, the cured sample is cut into individual sheets to form a plurality of optical film.

In the sixth step, the release film is separated from the optical film.

In the manufacturing method of the optical film, the photocurable resin is an UV curing resin.

In the manufacturing method of the optical film, the photocurable resin is an UV curing resin.

In the manufacturing method of the optical film, the viscosity of the photocurable resin is above 250 cps. Furthermore, the viscosity for the photocurable resin between 250 cps and 600 cps is preferred.

The above and other aspects, features, and advantages of the present invention will become more apparent from the following detailed description when taken in conjunction with the accompanying drawings.

### BRIEF DESCRIPTION OF THE DRAWINGS

FIG. 1 is a front view of a conventional brightness enhancement film.

FIG. 2A to FIG. 2D shows a manufacturing process of an optical film according to an embodiment of the present invention.

FIG. 3 shows the brightness enhancement film in the embodiment of the present invention.

FIG. 4 shows the forming mold for manufacturing the optical film with diffusion capability.

FIG. 5 shows the diffusion film in the embodiment of the present invention.

### DETAILED DESCRIPTION OF THE INVENTION

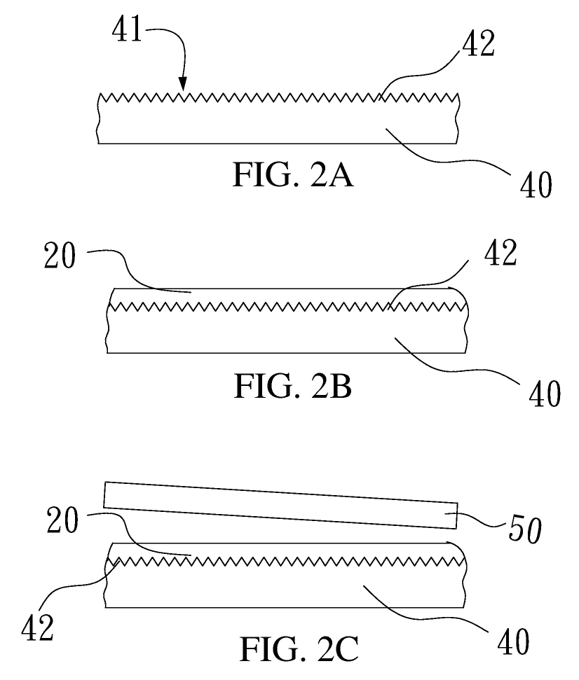

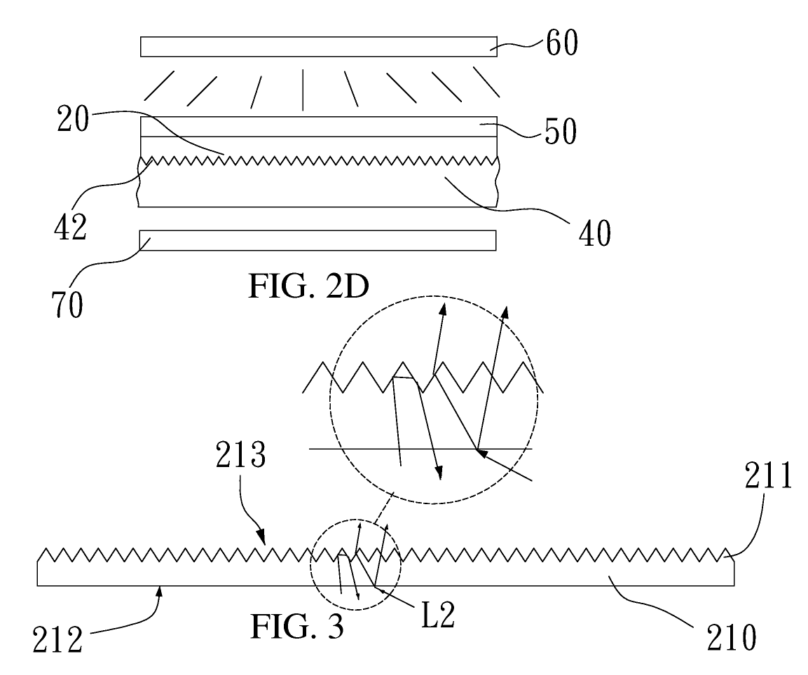

Referring to FIG. 2A to FIG. 2D, FIG. 2A to FIG. 2D shows the manufacturing process of the optical film in an embodiment of the present invention. Referring to FIG. 2A, a forming mold 40 is provided. A plurality of second microstructures 42 is disposed on a surface 41 of the forming mold 40. The second microstructures 42 are in the shape of prismatic trough. The material of the forming mold 40 is made of metal, for example, nickel and copper. Otherwise, the release agent, can be made of, for example, Teflon and is coated on the surface 41 of the forming mold 40.

Referring to FIG. 2B, a curing glue 20 is coated on the surface 41 of the forming mold 40. The viscosity of the curing glue 20 is above 250 cps, and the preferred viscosity of the curing glue 20 is between 250 cps and 600 cps. The curing glue 20 is made by mixing together the photocurable resin and the thermosetting resin. Compared to the curing glue 20 as a whole, the percentage weight of the thermosetting resin is about 1%˜5%. Herein, the photocurable resin is cured when it is illuminated by light at a specified range of wavelengths band. In this embodiment, the photocurable resin is an UV curable resin, which is cured after being illuminated by ultraviolet radiation.

The UV curable resin is widely used because of its beneficial characteristics, such as for example, higher toughness, easy to forming, and convenient to processing. The UV curable resin is mainly comprised of oligomers, for example, polyester acrylic oligomer, epoxy acrylic oligomer, or polyurethane acrylic oligomer. Furthermore, a reactive monomer and a photo initiator can be added into the UV curable resin, in order to improve the performance characteristics and reaction rate of the UV curable resin. The thermosetting resin is made for example of polyester or polyurethane.

Referring to FIG. 2C, a pressing plate 50 is covered on the curing glue 20. The pressing plate 50 is made of a transparent material. A release film 80 is disposed between the pressing plate 50 and the curing glue 20. The release film 80 is made of a transparent material, for example, polyethylene terephthalate, oriented polypropylene or other transparent material that would not crosslink with the curing glue 20. Furthermore, a small amount of additives is coated on the release film 80, to allow the release film 80 to be adhered on the curing glue 20.

Referring to FIG. 2D, a light source 60 is used to illuminate the curing glue 20. During the meantime, a heat pipe 70 is used to heat the curing glue 20. Because the pressing plate 40 is made of a transparent material, the light from the light source 50 can pass through the pressing plate 40 and the release film 80, and then to illuminate on the curing glue 20. Thereafter, the photocurable resin inside the curing glue 20 would undergo chemical reactions and begin to be cured. Furthermore, the thermosetting resin would undergo more reactions and begin to be cured by absorbing the heat from the heat pipe 70. In the embodiment, the light source 60 is a ultraviolet light source. In addition, the heat pipe 70 can be replaced by other heating devices. For example, the curing glue can be baked by hot wind.

After a specified period of time, the curing glue 20 will become completely cured. Because the release film 80 is located between the curing glue 20 and the pressing plate 50, the pressing plate 50 can be removed. In this embodiment, Teflon is coated onto the forming mold 40, so the curing glue 20 can be easily removed from the forming mold 40. Afterwards the curing glue 20 is cut into a plurality of brightness enhancement films 210 (as shown in FIG. 3). The brightness enhancement film 210 has a plurality of first microstructures 211. At this moment, the release film 410 is still adhered on the bottom side of the brightness enhancement film 210. Because the release film 80 is adhered on the brightness enhancement film 210 by means of only a small amount of additives, the release film 80 can be easily detached or removed. In view of preventing from environmental contamination during shipment and storage, the release film 80 is not removed until when the brightness enhancement film 210 is ready to be used. Moreover, in order to protect the first microstructures, a protective film can be adhered on the top surface of the brightness enhancement film 210.

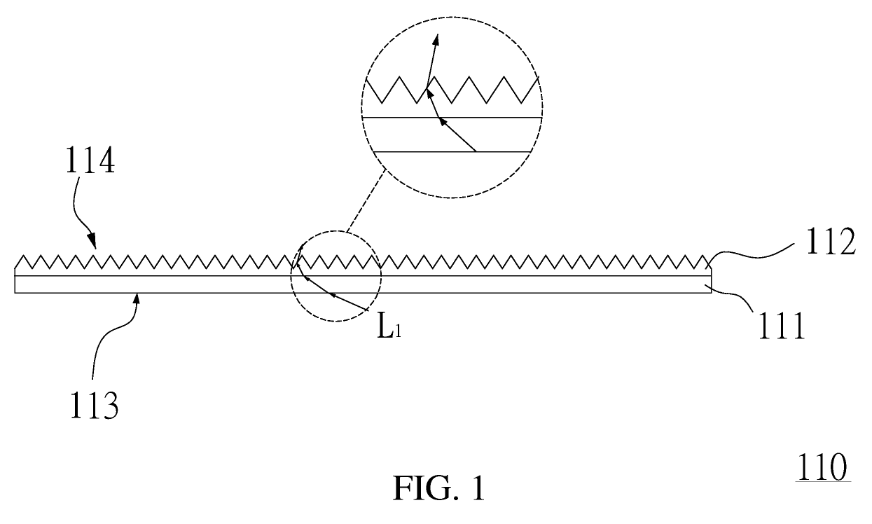

Compared to the brightness enhancement film 110 in FIG. 1, the brightness enhancement film 210 according to the present embodiment of the present invention has no base plate, therefore the material cost and thickness can be reduced. In this embodiment, the thickness of the brightness enhancement film 210 is preferably maintained above 30 μm, in order to ensure the brightness enhancement film 210 to be able to maintain at a predetermined acceptable level of mechanical strength. Herein, the thickness of the brightness enhancement film 210 is defined to be the distance from the incident surface 212 to the peak of the first microstructures 211. After entering into the incident surface 213 of the brightness enhancement film 210, the light L2 passes through only one layer of medium. Hence, as compared to the brightness enhancement film 110, the loss of light would be decreased. Furthermore, design variables which the designer must consider would be reduced, so that the degree of difficulty relating to design will be lowered.

From above, those skilled in the art would appreciate that the brightness enhancement film 210 come to have better properties and lower cost.

In general, as the second microstructures 42 are more densely distributed, it becomes more difficult to detach the curing glue 20 away from the forming mold 40. Therefore, it is better to coat the release agent on the surface 41 of the forming mold 40, so that the curing glue which has been cured can then be more easily detached or taken away from the forming mold 40. If the distribution of the second microstructures 42 is less populated and looser, it is then not necessary to coat the release agent onto the surface 41 of the forming mold 40.

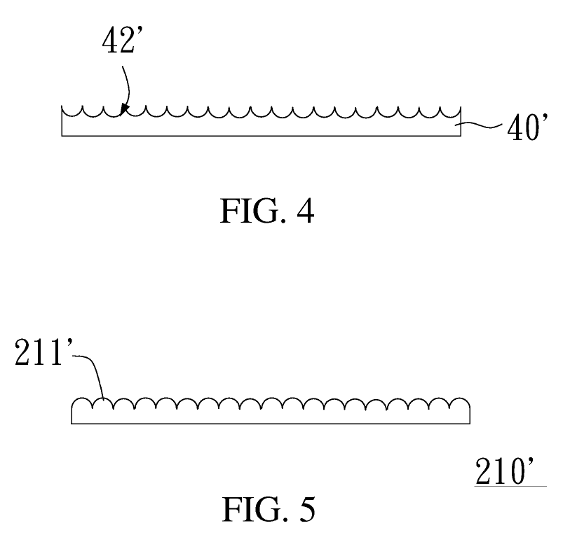

By means of the manufacturing process shown in FIG. 2A to FIG. 2D, not only the brightness enhancement film 210 but also the optical film with diffusion capability can be produced. Referring to FIG. 4, FIG. 4 shows the forming mold 40′ used for manufacturing the optical film with diffusion capability. One difference between the forming mold 40′ and the forming mold 40 (shown in FIG. 2A) is that the second microstructures 42′ on the forming mold 40′ is in the shape of a semi-spherical trough. By coating the curing glue 20 (shown in FIG. 2B) on the forming mold 40′ and undergoing the process shown in FIG. 2C and FIG. 2D, the diffusion film 210′ shown in FIG. 5 shall be produced. The thickness of the diffusion film 210′ is between 0.1 mm and 0.2 mm according to the present embodiment. Because of its hemi-spherical shape, the light will be diffused by the first microstructures 211′. In FIG. 5, the first microstructures 211′ are arranged at equal intervals, but those skilled in the art can easily arrange the first microstructures 211′ in a random formation.

If the curing glue is to be totally comprised of the photocurable resin (hereinafter the curing glue is referred to as the second curing glue), the optical film can be easily deformed and broken apart. The reason for this is herein described in detail. When the second curing glue which is totally comprised of photocurable resin is illuminated by light, the outer portion of the second curing glue will be cured earlier than the inner portion thereof. If the illuminating duration for the second curing glue is equal to that for the curing glue 20 shown in FIG. 2D, some uncured curing glue would be remaining inside the optical film (hereinafter referred to as the second optical film) made from the second curing glue. Or, a longer illuminating duration is required to permit the second curing glue to be totally cured, however, this will lead to reduced production rate.

After performing a temperature cycling test, the shrinkage rate of the second optical film would be larger than that of the brightness enhancement film 210. Said this temperature cycling test is typically used to assess whether the optical film is able to perform properly under harsh operating conditions and environments. If the test is passed, the optical film shall have longer service life.

During the temperature cycling test, the set temperature in the test environment is raised and maintained at a higher temperature (for example: 85° C.) for a period of time (for example: 1 hour). Then the set temperature in the test environment is decreased and maintained at a lower temperature (for example: −35° C.) for a period of time (for example: 1 hour). Thereafter, the above cycle is repeated for 4˜5 days. It is found that the second optical film shrank 2%, but the brightness enhancement film 210 only shrank 0.31%. From the above, those skilled in the art should know the brightness enhancement film 210 would be better able to withstand the temperature variations of the external environment.

Because there is uncured second curing glue left in the interior of the second optical film, the outer portion and the inner portion of the second optical film will undergo different deformation. Hence some cracks will be generated on the surface of the second optical film, the uncured second curing glue located in the interior of the second optical film will be dissipated from the cracks, and then the second optical film will be shrunk.

The brightness enhancement film 210 manufactured from the curing glue 20 is mainly comprised of the photocurable resin and the thermosetting resin. After being heated, the thermosetting resin will release free radicals. The free radicals will further chemically react with the photocurable resin, so as to allow the uncured curing glue to be cured. Therefore, the uncured curing glue is thus made to be more difficult to be left inside the brightness enhancement film 210, and thereby the yield rate will be increased.

If the percentage weight of the thermosetting resin is less than 1%, more uncured curing glue will be left inside the brightness enhancement film 210. If the percentage weight of the thermosetting resin is more than 1%, the brightness enhancement film 210 will become brittle. Therefore, the percentage weight of the thermosetting resin is about 1%˜5% when compared to the weight of the curing glue 20 in this embodiment.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An optical film, disposed in the backlight assembly, fabricated by a process comprising:
mixing a photocurable resin and a thermosetting resin to form a curing glue, wherein a percentage weight of the thermosetting resin is about 1%˜5% of the weight of the curing glue as a whole;
illuminating and heating the curing glue to cure the curing glue; and
forming the optical film, wherein a plurality of first microstructures is disposed on the optical film.

2. The optical film of claim 1, wherein the photocurable resin is an UV curing resin.

3. The optical film of claim 1, wherein the first microstructures, comprising of the shape of a prism, are disposed on an emergent surface of the optical film.

4. The optical film of claim 1, wherein the first microstructures, comprising of a hemi-spherical shape, are disposed on the emergent surface of the optical film.

5. The optical film of claim 1, wherein the thickness of the optical film is above 30 μm.

6. The optical film of claim 1, wherein the thermosetting resin is selected from the group consisting of polyester and polyurethane.

7. A manufacturing method of optical film, comprising:
coating an uncured curing glue on a forming mold, wherein a plurality of second microstructures is disposed on the forming mold, the curing glue is coated on the second microstructures, the curing glue is made by mixing together the photocurable resin and the thermosetting resin, and the percentage weight of the thermosetting resin is about 1%˜5% compared to the weight of the curing glue as a whole;
covering a pressing plate on the curing glue, wherein a release film is disposed between the pressing plate and the forming mold;
illuminating and heating the curing glue to cure the curing glue;
separating the cured curing glue from the pressing plate and the forming mold;
cutting the cured curing glue to form a plurality of optical film; and
detaching the release film from the optical film.

8. The manufacturing method of the optical film of claim 7, wherein the photocurable resin is an UV curing resin.

9. The manufacturing method of the optical film of claim 7, wherein the viscosity of the photocurable resin is above 250 cps.

10. The manufacturing method of the optical film of claim 9, wherein the viscosity of the photocurable resin is between 250 cps and 600 cps.

11. The manufacturing method of the optical film of claim 7, wherein the thermosetting resin is selected from the group consisting of polyester and polyurethane.

12. The manufacturing method of the optical film of claim 7, wherein a release agent is coated on the surface of the forming mold.
